(19) United States
(12) Patent Application Publication
(10) Pub. No.: US 2003/0221768 A1
(43) Pub. Date: Dec. 4, 2003

(54) Method of making polyolefin spunmelt/film composite material and product made thereby

(75) Inventors: Moshe Goldwasser, Tel Aviv (IL); Achai Bonneh, Kokhav (IL)

Correspondence Address: Breiner & Breiner, L.L.C., P.O. Box 19290, Alexandria, VA, 22320-0290, US

(73) Assignee: Avgol Ltd., Holon (IL)

(21) Appl. No.: 10/157,840

(22) Filed: May 31, 2002

(51) Int. Cl. B32B 31/00

(52) U.S. Cl. 156/167; 156/176; 442/401

(57) ABSTRACT

A method of making spunmelt/film composite materials, as well as the product of the method, is described. The method is a continuous in-line process including in-line production of a continuous filament spunmelt web, placement of a film on the spunmelt web, optional placement of at least one nonwoven fabric on the film, joining or bonding of the formed layered structure by subjecting the layered structure to calendering using heated rolls. The basis weight of the continuous filament spunmelt web is from about 13.5 gsm to about 100 gsm and of the polyolefin film from about 10 gsm to about 40 gsm. The total composite basis weight tolerance ranges from about 25 gsm to about 150 gsm. No adhesive or secondary thermal bonding is utilized in the process.

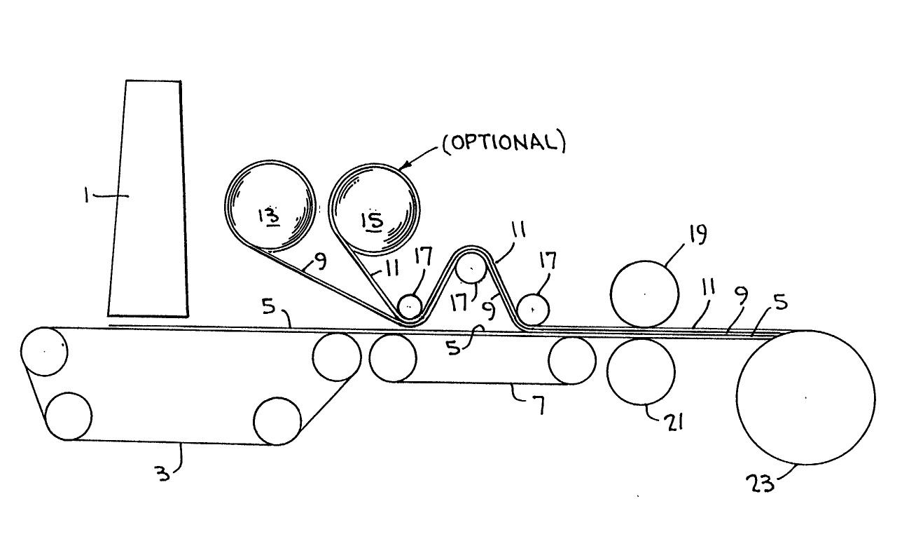

### FIELD OF INVENTION

The invention is directed to a method for making a spunmelt/film composite material in-line using heated calender rollers to bond the layers of material in the absence of an adhesive, and the composite material resulting from the method. The composite material is suitable for use in civil engineering applications (e.g., roofing, house wraps, etc.), personal care products (e.g., baby diapers, feminine hygiene, adult incontinent products, etc.) and for protective garments in medical and industrial environments.

### BACKGROUND OF THE INVENTION

The present invention is directed to providing a composite material including a spunmelt filament web and a film material. In conventional processes, individual layer materials which are to be a component of a composite material are individually made and wound onto a storage roll. For example, a nonwoven fabric is separately made (including bonding of the filaments/fibers which make up the fabric) and a film is separately made. Thereafter, the storage rolls are provided on a line where the layer materials are unwound and layered together in a desired order. The ready-made layers are joined or laminated together by use of an adhesive between the layers or alternatively through a separate heated calendering process. Accordingly, prior art processes require multiple separate line processes, use of separate equipment, additional time, additional material and the subjecting of the material to added heat treatments which serve to degrade the material forming the composite. An example of such a laminate is disclosed in U.S. Pat. No. 5,910,225.

Therefore, an on-line process not utilizing an adhesive or added heat processes would be advantageous. Additionally, cost would be decreased based on savings in time, material and equipment.

### OBJECTS OF THE INVENTION

Accordingly, it is a primary object of the present invention to provide a method of making a spunmelt filament web/film composite material in one in-line process, in particular providing bonding of the layers forming the composite material in the absence of an adhesive.

A further object of the invention is to provide a composite material of dissimilar materials, such as films and spunmelt continuous filament webs, which are joined by simple heat and pressure.

A further object is to provide a process which eliminates bonding agents and reduces the number of heat applications of the material components and composite material to maintain functionality, such as breathability and softness, of the composite as well as achieve minimal degradation of the material.

### BRIEF DESCRIPTION OF THE INVENTION

The invention is directed to polyolefin spunmelt continuous filament web/film composite materials and a method of making such composite materials. The composite material is made up of dissimilar materials, i.e., film and spunmelt continuous filament web(s), which are joined together in the absence of adhesives or secondary thermal bonding. The structure and method of the invention involves an in-line formation of a spunmelt continuous filament web(s) and subsequent in-line joinder to a film and, optionally, at least one other nonwoven material.

More particularly, the method of making a polyolefin spunmelt continuous filament web/film composite material includes forming on a moving belt a web of spunmelt polyolefin fibers. A breathable or non-breathable polyolefin film is positioned on top of the formed web as the web is moved to a winder in order to provide a layered structure. Optionally, at least one other layer, such as a nonwoven material, may be positioned on top of the film. Thereafter, the formed layered structure is subjected to calendering utilizing heated rolls in order to join or bond the layers together. The composite material is then wound on a winder. The polyolefin film is positioned atop the web at a speed which is the same as the speed at which the web is moving. Preferred speed of application is in a range of from about 10 to about 100 meters per minute (m/min).

In a preferred embodiment of the composite material, the basis weight of the web of spunmelt fibers is from about 13.5 gsm to about 100 gsm (grams per square meter) and the basis weight of the polyolefin film is from about 10 gsm to about 40 gsm. The total composite basis weight tolerance ranges from about 25 gsm to about 150 gsm.

The polyolefin of the fibers and/or films of the composite material is preferably polypropylene, polyethylene, copolymers of polypropylene and polyethylene, or a composite of polypropylene and polyethylene.

The continuous in-line process of the invention allows for the film to be pre-stretched during the formation process which serves to enhance the “Z” directional properties of the composite. This is due to film/nonwoven composite relaxation after thermal bonding. The elimination of bonding agents or secondary thermal bonding results in cost savings since the overall process involves less stages, as well as results in preservation of more characteristics of the original materials, such as breathability and softness. Minimal degradation of the film and spunmelt web occurs since less heat is utilized in the process.

The composite web material of the invention can be used in various applications. For example, the composite material is useful in civil engineering applications (e.g., roofing, house wraps and the like), in personal hygiene products (e.g., diapers, feminine hygiene products, adult incontinent products and the like), and in protective garments in medical and industrial environments, etc.

### BRIEF DESCRIPTION OF DRAWING

The sole FIGURE is a schematic illustrating a production line for making a spunmelt/film composite material in accordance with the invention.

### DETAILED DESCRIPTION OF PRESENTLY PREFERRED EMBODIMENTS

The invention concerns a composite material made of dissimilar materials, i.e., film and continuous filament spunmelt web(s), which are made in a continuous in-line process. The process of the invention is more cost and time effective as compared to conventional multi-stage lamination processes. Further, the process of the invention provides for improved material properties based on the ability to bond in the absence of adhesive and secondary thermal calendering which allows the formed product to have minimal degradation as to material and thus properties.

The composite material has two essential layers, a film layer and a spunmelt layer. Optionally, one or more other layers may be included. The spunmelt layer and film layer are preferably formed of a polyolefin, more preferably polypropylene, polyethylene, copolymers of polypropylene and polyethylene, or composite of polypropylene and polyethylene. The film is preferably a breathable polyolefin. The film, however, can be any film which can be bonded by heat and pressure, including nonbreathable films. The basis weight of the spunmelt layer is from about 13.5 gsm to about 100 gsm. The basis weight of the film is from about 10 gsm to about 40 gsm. The total composite basis weight tolerance ranges from about 25 gsm to about 150 gsm.

With reference to the sole figure, in the method of the invention, the spunmelt fibers are formed at station 1 in a conventional manner as known to one skilled in the art, such as for example by extrusion. Spunmelt fibers formed are allowed to fall to a moving belt 3 to form a spunmelt web 5 on belt 3. Spunmelt web 5 then moves along continuing moving belt 7 where a film 9 and optionally at least one nonwoven material 11 are positioned or laid on top of spunmelt web 5. Film 9 is received from unwinder 13 and the optional nonwoven material 11 is received from the unwinder 15. Tension rollers 17 are utilized to control the tension, placement and speed of the film and nonwoven material in relation to web 5. Film 9 is positioned upon web 5 at the same speed at which web 5 is moving along belt 7. A preferred speed is in a range of from about 10 to about 100 m/min. This is beneficial to insure aligned placement without pulling of one material upon another such as could occur if one moved at a lower speed.

The layered structure of web 5, film 9 and optional nonwoven material 11 is then moved downstream for heated calendering, e.g., by a heated engraving roller 19 and heated smooth roller 21. The heat and pressure serve to join or bond the multi-layer structure. Following calendering, the joined structure is taken up by winder 23. Once wound to a desired capacity, the wound material will be removed from the winder and taken to storage or a point of use depending upon the application to which the material will be used.

The composite fabric(s) of the invention can be applied to various uses. For example, the composite fabric(s) may be used in civil engineering applications such as roofing, house wraps and the like; in personal hygiene applications, such as a backsheet material in a diaper; for protective garments in medical and industrial environments; and the like.

The in-line method of the invention is advantageous in providing a composite material of dissimilar materials which are joined by means other than conventional adhesives or a secondary thermal bonding stage. In terms of the process, savings are present with respect to cost and time. Fewer stages and thus less equipment is necessary, added cost of adhesive is unnecessary. In terms of the material produced, the elimination of adhesive or secondary thermal bonding preserves more properties of the original materials which are joined together. Due to lack of adhesive and less exposure to heat, the material's functionality (such as breathability and softness) are less compromised, and the reduced exposure to heat results in minimal degradation of the original material. Additionally, the method allows the film to be “pre-stretched” during the formation process to enhance the “Z” directional properties of the finished composite material. Such does not interfere with on-going method. Thus, the in-line continuous method of the present invention has numerous advantages over conventional processes where several various layers are separately formed at individual lines and then are combined off-line.

The invention is not to be restricted to the above described embodiments. Modifications may be introduced, in particular as regards the constitution of the various components or by substituting equivalent techniques, without thereby transcending the protected scope of the invention.

It is claimed:

1. Method of making a composite material comprising
forming on a moving belt a web of spunmelt polyolefin fibers;
positioning atop said web of spunmelt polyolefin fibers as said web is moved to a winder, a polyolefin film to provide a layered structure;
calendering said layered structure utilizing a pair of heated rollers to bond said web and said film together; and
winding said layered structure.

2. Method according to claim 1 further comprising, prior to said calendering, positioning atop said polyolefin film at least one nonwoven material.

3. Method according to claim 1 wherein said polyolefin film is a breathable film.

4. Method according to claim 1 wherein said polyolefin film is a non-breathable film.

5. Method according to claim 2 wherein said nonwoven material is pre-formed.

6. Method according to claim 1 wherein the basis weight of said web of spunmelt fibers is from about 13.5 to about 100 gsm and of said polyolefin film from about 10 gsm to about 40 gsm.

7. Method according to claim 1 wherein said polyolefin film is positioned atop said web at a speed which is essentially equal to a speed at which the web is moving.

8. Method according to claim 1 wherein said polyolefin film is pre-stretched prior to positioning said film atop said web.

9. Method according to claim 1 wherein said bond between said polyolefin film and said web is provided in the absence of an adhesive.

10. Method according to claim 1 wherein said polyolefin fibers are polypropylene fibers, polyethylene fibers, fibers of a copolymer of polypropylene and polyethylene, or a composite of polypropylene and polyethylene fibers.

11. Method according to claim 1 wherein said polyolefin film is polypropylene film, polyethylene film, film of a copolymer of polypropylene and polyethylene, or a composite film of polypropylene and polyethylene.

12. Product made according to any one of claims 1-11.

13. Product made according to claim 12 wherein said product is, or is present as a component of, a civil engineering product, a personal care product, or a protective medical or industrial product.

14. A composite material comprising
an on-line formed web of spunmelt polyolefin fibers having a basis weight of from about 13.5 to about 100 gsm,
a polyolefin film having a basis weight of from about 10 gsm to about 40 gsm, and
optionally, at least one layer of nonwoven material,
wherein said web, said film and said at least one layer of nonwoven material are bonded together by heat and pressure, in the absence of an adhesive.

15. A composite material according to claim 14 wherein said polyolefin film is a breathable film.

16. A composite material according to claim 14 wherein said polyolefin film is a non-breathable film.

17. A composite material according to claim 14 wherein said polyolefin fibers are polypropylene fibers, polyethylene fibers, fibers of a copolymer of polypropylene and polyethylene, or a composite of polypropylene and polyethylene fibers.

18. A composite material according to claim 14 wherein said polyolefin film is polypropylene film, polyethylene film, film of a copolymer of polypropylene and polyethylene, or a composite film of polypropylene and polyethylene.
